(19) United States
(12) Patent Application Publication
(10) Pub. No.: US 2009/0013659 A1
(43) Pub. Date: Jan. 15, 2009

(54) Apparatus and Method for Discontinuous Welding of Metallic Fibers, Method for Filtering Exhaust Gases and Exhaust-Gas Treatment Component

(75) Inventor: Gottfried Wilhelm Haesemann, Kurten (DE)

Correspondence Address: LERNER GREENBERG STEMER LLP, P O BOX 2480, HOLLYWOOD, FL, 33022-2480, US

(73) Assignee: EMITEC GESELLSCHAFT FUR EMISSIONSTECHNOLOGIE MBH, Lohmar (DE)

(21) Appl. No.: 12/172,570

(22) Filed: Jul. 14, 2008

Related U.S. Application Data
(63) Continuation of application No. PCT/EP2007/000233, filed on Jan. 12, 2007.

(30) Foreign Application Priority Data
Jan. 13, 2006 (DE) 10 2006 001 833.8

(51) Int. Cl. B23K 11/00; B01D 46/00; B01D 39/12

(52) U.S. Cl. 55/525; 219/78.01; 219/117.1; 95/273

(57) ABSTRACT

An apparatus and a method for welding metallic fibers to form a knitted fabric having a predetermined width, include feeding a composite of metallic fibers to an apparatus for welding the fibers to form a knitted fabric, and separately welding a plurality of partial sections of the composite in a time period, in which the composite is at a standstill, for example through the use of a plurality of welding electrode pairs which are disposed over the width of the composite. A method for filtering exhaust gases and an exhaust-gas treatment component are also provided.

### CROSS-REFERENCE TO RELATED APPLICATION

This is a continuing application, under 35 U.S.C. § 120, of copending International Application No. PCT/EP2007/000233, filed Jan. 12, 2007, which designated the United States; this application also claims the priority, under 35 U.S.C. § 119, of German Patent application DE 10 2006 001 833.8, filed Jan. 13, 2006; the prior applications are herewith incorporated by reference in their entirety.

### BACKGROUND OF THE INVENTION

### Field of the Invention

The present invention relates to an apparatus and a method for welding metallic fibers to form a knitted fabric having a predetermined width. Such metallic knitted fabrics are preferably used in the field of exhaust-gas treatment, for example as filter or cushioning material. The invention also relates to a method for filtering exhaust gases and an exhaust-gas treatment component.

International Publication No. WO 2004/039580 A1, corresponding to U.S. Patent Application Publication No. US 2006/0014451 A1, discloses a method of producing a porous, plate-like metal composite. There, it is proposed that the metallic fibers be pressed and welded to one another in one processing step. In order to carry out the welding method, the metal fibers are introduced into a welding apparatus provided for that purpose. In order to weld the fibers, a pile of metallic fibers is disposed between two electrodes having a planar construction, which provide a pressure force with regard to the pile that is sufficient for the welding. The welding method proposed is a pulse welding method, preferably a capacitor discharge welding method.

Although the known welding method has proved successful for producing such metallic nonwoven fabrics, there is partly the risk, especially with regard to series production, that the welding conditions cannot be uniformly maintained over the entire width, such that the nonwoven fabric may ultimately have undesirable fluctuations with regard to certain material characteristics.

### SUMMARY OF THE INVENTION

It is accordingly an object of the invention to provide an apparatus and a method for discontinuous welding of metallic fibers, a method for filtering exhaust gases and an exhaust-gas treatment component, which overcome the hereinafore-mentioned disadvantages and at least partly solve the technical problems of the heretofore-known devices and methods of this general type. In particular, an apparatus is to be specified which also ensures the production of metallic fiber knitted fabrics of high quality within the scope of series production. In addition, the apparatus is to have a simple construction and permit a high welding rate.

With the foregoing and other objects in view there is provided, in accordance with the invention, an apparatus for welding metallic fibers to form a knitted fabric having a predetermined width. The apparatus comprises a plurality of welding electrode pairs to be distributed over the predetermined width of the knitted fabric to be formed and through which the metallic fibers are to be passed. At least one stroke configuration effects a relative movement of at least one welding electrode of a welding electrode pair. At least one welding control feeds a welding current as a function of a contact between a welding electrode pair and the metallic fibers. A feed control for moving the knitted fabric feeds the knitted fabric as a function of a state of the at least one stroke configuration.

With regard to the welding electrode pairs, it should be noted that the welding electrode pairs together cover the entire width of the knitted fabric or of the loose composite of metallic fibers (possibly with the exception of a narrow edge region to be subsequently processed). To this end, the welding electrode pairs can preferably be disposed in alignment (but this is not absolutely necessary), in such a way that a configuration of the welding electrode pairs offset in the feed direction of the knitted fabric is also possible.

A relative movement of at least one welding electrode is now effected through the use of the stroke configuration, which means in particular that one of the two welding electrodes is not moved during the welding operation. The welding electrode disposed below the composite is preferably constructed as such a stationary welding electrode. The welding electrode disposed at the top can perform a stroke movement relative thereto, in such a way that the compressing and welding of the metallic fibers takes place with the deflected position in which the welding electrodes are at the smallest distance from one another.

In principle, it is possible for each welding electrode pair to be activated independently of the others through the use of the stroke configuration, wherein prolonged process times would possibly have to be tolerated in this case. Especially preferred, however, is a configuration in which all of the welding electrode pairs are moved simultaneously and/or parallel to one another through the use of the stroke configuration. In this case, it is furthermore preferred that each welding electrode pair be equipped with a separate transformer in order to ensure a welding process that can be controlled and reproduced in an even better manner.

In order to carry out the welding process, each welding electrode pair advantageously has a separate power supply and/or even its own power source. The power supply and power source can be controlled through a common welding control. However, it is also possible for a separate welding control to be provided for each welding electrode pair. The welding control has, in particular, the function of supplying current precisely only to the welding electrode in contact with the fiber knitted fabric.

The feed control serves to discontinuously feed the knitted fabric in such a way that the knitted fabric is stationary itself during the welding operation and is transported further by a defined feed distance in the intermediate phases.

In accordance with another feature of the invention, the welding electrode pairs have an effective area of 2 cm² to 10 cm². All of the welding electrode pairs preferably have the same effective area. In an especially preferred manner, the effective area is on the order of magnitude of 3 cm² to 6 cm². In this case, the effective area of a welding electrode pair extends in the direction of the width of the knitted fabric preferably over about 2 cm to 3 cm.

In accordance with a further feature of the invention, the stroke configuration moves all of the welding electrode pairs together. In this case, it is especially preferred that the stroke configuration is an eccentric drive. With such a stroke configuration, the movement of the individual welding electrode pairs relative to one another can be carried out at a high frequency and with exact guidance, for example in the manner of a camshaft.

In accordance with an added feature of the invention, it is especially preferred that the welding control in each case includes a transformer and a frequency-controlled converter, which can be matched to the movement of the stroke configuration. The frequency-controlled converter is preferably what is referred to as a “sine wave inverter”. It is therefore possible overall to set any desired welding frequency, such that very high processing speeds with regard to the welding of the fiber knitted fabric are possible.

In accordance with an additional feature of the invention, in order to be able to fully exploit such advantages precisely with regard to series production, measures are advantageously provided for realizing at least 300 strokes of a welding electrode per minute. It is especially preferred to realize 300 strokes to 500 strokes of the welding electrode per minute.

In accordance with yet another feature of the invention, especially in the case of the high thermal loads occurring in this case, a cooling system with regard to the welding electrode pair is advantageous in order to maintain a welding process of uniform quality. To this end, the welding electrodes are preferably constructed with a device which can be operated with a heat exchanger medium.

In accordance with yet a further feature of the invention, a position-recognition unit is situated upstream of the apparatus and with which the position of the metallic fibers relative to the apparatus can be at least checked or set. The position-recognition unit is advantageously also suitable for first of all checking the position of the metallic fibers relative to the welding electrode pair and for correcting the position, if necessary. This can be achieved, for example, with a transversely movable linear drive of the feed. This can ensure that the knitted fabric is exactly oriented relative to the configuration of the welding electrode pairs.

In accordance with yet an added feature of the invention, it is advantageous that a seaming unit is disposed downstream of the apparatus. The seaming unit at least compacts or welds an edge region of the knitted fabric, and advantageously even carries out both processes. The task of the seaming unit is, in particular, to strengthen the edge and thus permit further manipulation of the fiber knitted fabric. For this purpose, special weld seams can be provided in the edge region. However, it is also possible for parts of the fibers to be cut off there or for them to be connected to additional elements, such as foil-like strips for example.

With the objects of the invention in view, there is also provided a method for welding metallic fibers to form a knitted fabric having a predetermined width. The method comprises:
a) feeding a composite of metallic fibers to an apparatus for welding the fibers to form the knitted fabric; and
b) separately welding a plurality of sections of the composite in a time segment in which the composite is stationary.

In an especially preferred manner, this method is carried out with the apparatus described above according to the invention. The method is thus suitable, in particular, for the discontinuous production of metallic fiber knitted fabrics in series operation.

In accordance with another mode of the invention, step b) includes a welding operation in an individual section of less than 4 milliseconds. This means, in particular, that the stroke movement of a welding electrode, the associated compacting of the metallic fibers and the welding through the use of a power supply are thus carried out in this section. For the case in which welding electrode pairs having a relatively small effective area are used, e.g. less than 10 mm² (square millimeters), step b) is preferably carried out within a range of 0.5 to 2 milliseconds. Undesirable heat conduction can thus be avoided.

In accordance with a further mode of the invention, step b) is carried out at a repeat rate of at least 300 welding operations per minute. A repeat rate of up to 500 welding operations per minute is especially preferred.

In accordance with an added mode of the invention, the individual welding operations are carried out with at least one of the following parameters:
a) a welding electrode contact pressure within a range of 5,000 to 50,000 N/Cm²;
b) an (effective) welding current within a range of 300 to 1,200 amps;
c) a welding power within a range of 500 to 20,000 watts.

With the welding parameters specified, it was possible to generate durable and uniformly distributed welded connections between the metallic fibers, in such a way that finally a knitted fabric of uniform quality could be produced. With regard to the welding electrode contact pressure, it may be noted that, in the case of effective areas of the welding electrode pairs of at least 2 cm², work should preferably be carried out in this case within the range of 20,000 to 50,000 N/cm². In an especially preferred manner, the specified (effective) welding current should be selected within a range of 400 to 800 amps, with a plurality of such welding pulses possibly being generated during a stroke (e.g. a test pulse, characteristics such as, for example, current intensity and/or voltage drop being detected, and at least one further working pulse being carried out within the same effective area as a function of the characteristics).

In accordance with an additional mode of the invention, step a) is advantageously carried out with an average feed of at least 3 m/min. Higher feeds, for example of up to 6 m/min or 8 m/min, are especially preferred.

In accordance with yet another mode of the invention, in order to also especially avoid incorrect contact between the welding electrodes or inadequate overlap of the effective area with the composite, the composite is oriented before step a) relative to the apparatus for the welding. That is to say, in particular, that the composite is oriented transversely to the apparatus. With regard to the orientation in the feed direction, it should be noted that there should preferably be no substantial overlaps of the welding regions, such that the discontinuous feed is substantially oriented to the extent of the effective area in the feed direction.

In accordance with yet a further mode of the invention, the knitted fabric is fed to a seaming unit after step b), with a predetermined width of the knitted fabric being set. To this end, it is possible to remove projecting sections of the knitted fabric, for example to cut them off. However, folding-down, welding or simple compaction can also be carried out, in such a way that ultimately the predetermined width is achieved. The seaming unit can also be used to permanently position reinforcing elements, sealing compounds and the like at the edge regions of the knitted fabric.

In accordance with yet an added mode of the invention, the knitted fabric is produced with at least one of the following properties:
a) fibers having a hydraulic fiber diameter of 10 to 100 μm;
b) fibers having a ratio of fiber length to hydraulic fiber diameter of 50 to 5,000;
c) fibers having variance of the fiber diameter of at most 50%;
d) a width of the knitted fabric of 5 to 500 mm;
e) a height of the knitted fabric of 0.1 to 10 mm;
f) a weight per unit area of the knitted fabric of 100 to 5,000 g/m²;
g) an increase in strength from the composite to the knitted fabric by at least a factor of 3;
h) a porosity of the knitted fabric of 50 to 85%.

With the objects of the invention in view, there is furthermore provided a method for filtering exhaust gases, which comprises filtering the exhaust gases with a knitted fabric produced with the apparatus according to the invention or by the method according to the invention.

With the objects of the invention in view, there is concomitantly provided an exhaust-gas treatment component for cleaning exhaust gases. The exhaust-gas treatment component comprises at least one knitted fabric produced with the apparatus according to the invention or by the method according to the invention.

The fibers may in principle have any desired fiber cross section (round, polygonal, etc.). Their form is therefore adapted in this case to a hydraulic fiber diameter which can be determined according to the following formula: 4*A/U, where A describes the fiber cross-sectional area and U describes the fiber circumference. The hydraulic fiber diameter preferably lies within a range of 20 to 50 μm (micrometers). Various fiber cross sections may also be used in a knitted fabric, in particular as a mixture or as individual, stacked layers. The configuration of the fibers relative to one another is not important, so that no restriction is made in this respect with the term “knitted fabric” and a “random orientation” of the fibers relative to one another is preferred.

In addition, the fibers advantageously have a ratio of fiber length to hydraulic fiber diameter (L/d_{hydr}) within the range specified above, with a range of 200 to 1,000 being preferred.

The variance of the fiber diameter is preferably limited to 10% especially for very uniform knitted fabric properties, wherein a variance in this case means a deviation upward and downward, that is to say, for example, +10% and −10% of the desired fiber diameter.

With regard to the use of such knitted fabrics in the automobile sector and in order to avoid very costly welding units, knitted fabrics having a width within a range of 20 to 200 mm and a height of 0.2 to 1.5 mm are preferred. With regard to the weight per unit area of such a knitted fabric, a range of 300 to 3,000 g/m² is preferred.

In addition, in order to illustrate the welding quality and/or the number and type of welded connections being generated, an increase in strength from the composite to the knitted fabric is specified. What is meant by this is that the composite of fibers can already be stressed in tension in a certain manner, since the fibers have already become interlocked due to their curvature or position. This “tensile strength” is now increased during the welding, in which case the increase in strength at least by a factor of 3, in particular at least by a factor of 6, and possibly even by a factor of 10, should be achieved in this case.

The knitted fabric produced with the apparatus according to the invention and/or with the method according to the invention is preferably used for filtering exhaust gases. In addition, the integration of such a knitted fabric in an exhaust-gas treatment component for cleaning exhaust gases is proposed.

Other features which are considered as characteristic for the invention are set forth in the appended claims, noting that the features recited individually in the claims can be combined with one another in any desired, technologically appropriate manner to provide further configurations of the invention.

Although the invention is illustrated and described herein as embodied in an apparatus and a method for discontinuous welding of metallic fibers, a method for filtering exhaust gases and an exhaust-gas treatment component, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, front-elevational view of a first embodiment variant of an apparatus according to the invention;

FIG. 2 is a plan view of a knitted fabric;

FIG. 3 is an enlarged, side-elevational view of a further embodiment variant of the apparatus according to the invention;

FIG. 4 is an enlarged, fragmentary, perspective view of a fiber knitted fabric; and

FIG. 5 is a fragmentary, perspective view of an embodiment variant of an exhaust-gas treatment component.

### DETAILED DESCRIPTION OF THE INVENTION

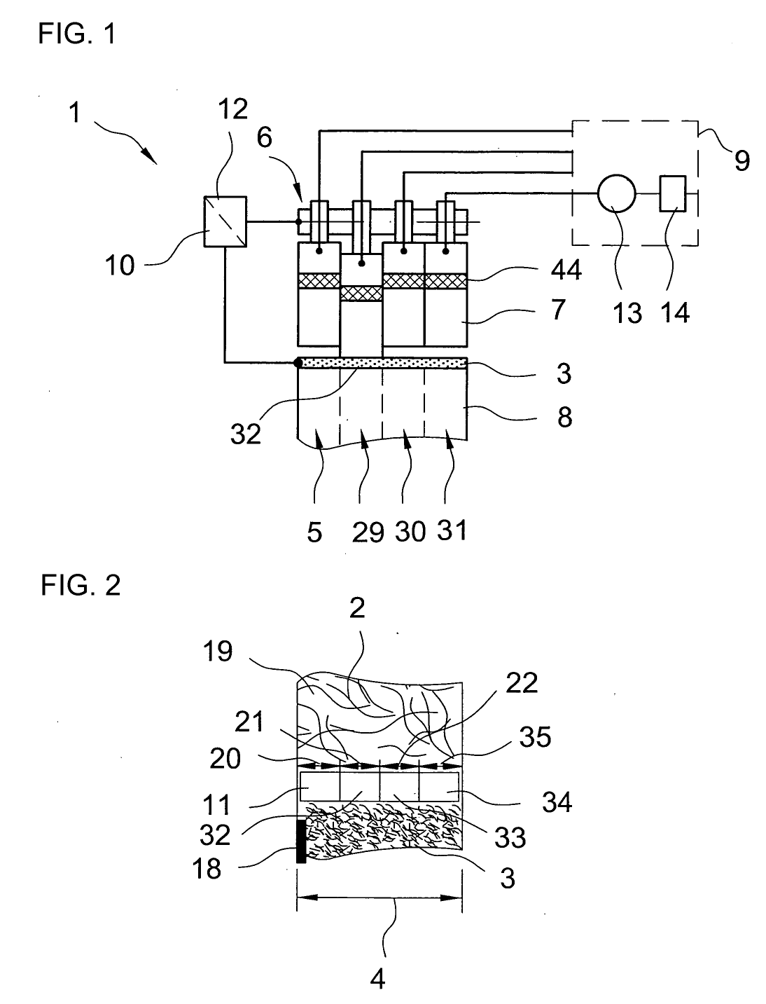

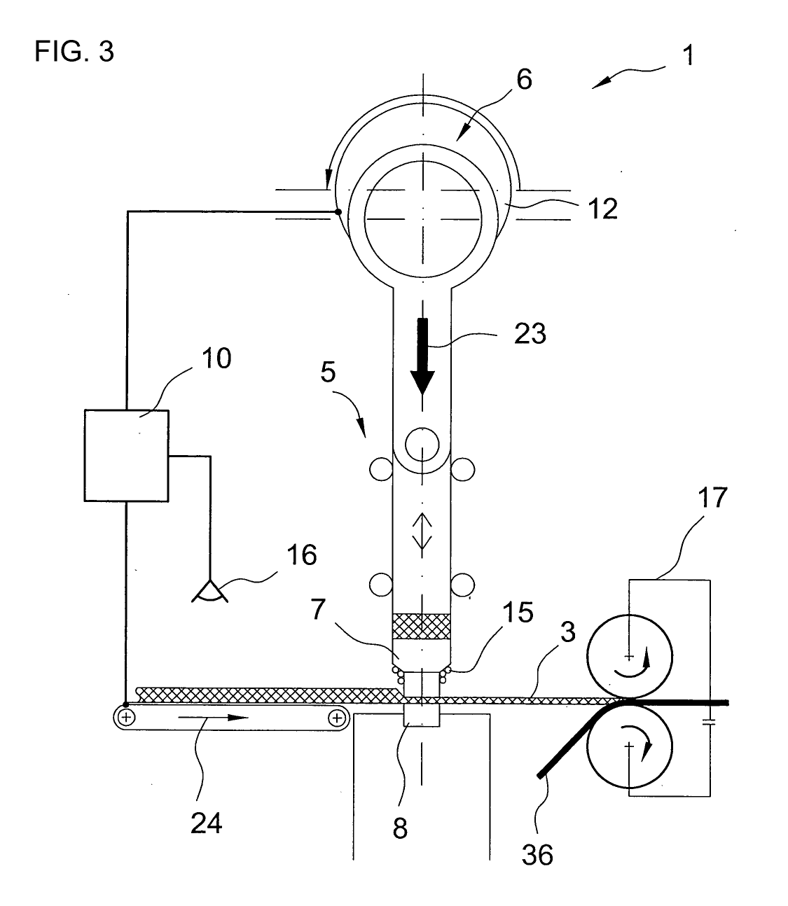

Referring now to the figures of the drawings in detail and first, particularly, to FIGS. 1 and 2 thereof, there is seen a diagrammatic illustration of an apparatus 1 according to the invention for welding metallic fibers 2 to form a knitted fabric 3. FIG. 1 shows a plurality of welding electrode pairs, namely four welding electrode pairs 5, 29, 30, 31, which are disposed so as to be distributed over a width 4 of the knitted fabric 3 and through which the metallic fibers 2 are passed. A stroke configuration 6 is provided in order to specifically produce a movement of the welding electrode pairs relative to one another. The stroke configuration 6 produces a movement of a first welding electrode 7 disposed at the top relative to a second welding electrode 8 disposed at the bottom in a fixed position. Each welding electrode pair 5, 29, 30, 31 is connected to a common welding control 9. A transformer 13 and a frequency-controlled converter 14 for each welding electrode pair 5, 29, 30, 31 are part of the welding control 9. A specific power supply to the knitted fabric 3 through the welding electrodes 7, 8 is thus ensured.

In the illustrated position of the apparatus 1, the second welding electrode pair 29 is carrying out the welding process at that instant, with the welding electrode 7 shown at the top being in contact with the knitted fabric 3 in a second effective area 32 and a current flow being realized for producing welded connections. A feed control 10 which advantageously works in a coordinated manner with an eccentric drive 12, ensures that the knitted fabric 3 is stationary during the welding. In view of the high processing speeds and/or high relative speeds of the first welding electrode 7 shown at the top, a compensation and/or insulation device, for example in the form of an elastomer 44, is provided. The elastomer 44 firstly brings about a relatively motionless position of the moved welding electrode at a bottom reversal point of the welding electrode 7 and secondly electrically isolates the welding electrode 7 from the rest of the apparatus.

FIG. 2 is intended to illustrate individual effective areas of the apparatus that have an effect on the knitted fabric 3. First of all, a loose composite 19 of metallic fibers 2, which is finally fed to the apparatus 1, is shown at the top in FIG. 2. The plurality of welding electrode pairs act together over the width 4 with effective areas 11, 32, 33, 34 on the composite 19 and generate compacted sections 20, 21, 22, 35 with welded connections. Finally, the knitted fabric 3 can be compacted further or additionally treated in an edge region 18. In addition, it may also possibly be desired for there to be no complete welded connection over the entire width of the knitted fabric, which can be achieved through the use of a distance between the individual welding electrode pairs. The welding electrode pairs may be set down if need be in a staggered manner for compensation during a subsequent stroke.

FIG. 3 shows a side view of a further embodiment variant of an apparatus 1 according to the invention. First of all, a first welding electrode pair 5 is again shown, including a first welding electrode 7 and a second welding electrode 8, between which the knitted fabric 3 is passed through discontinuously. To this end, a feed control 10 is provided for realizing a feed 24. The feed control 10 interacts in this case with a position-recognition unit 16 and the stroke configuration 6. After the desired feed 24 has been realized, the first welding electrode 7 is moved downward (as illustrated) through the use of the eccentric drive 12 (along with all of the other welding electrodes of the apparatus at the same time), in the course of which the knitted fabric 3 is compressed and welded. In the process, an electrode contact pressure 23 within a preferred range of 20,000 to 30,000 N/cm² is realized.

In addition, in order to be able to carry out the desired welding method with high effectiveness and uniform quality, a cooling system 15 is provided at the welding electrode 7.

Disposed downstream of the apparatus 1 is a seaming unit 17, in this case in the form of a roll-seam welding unit. In this case, a metallic edge foil 36 is turned down in the edge region 18 and welded to the knitted fabric 3.

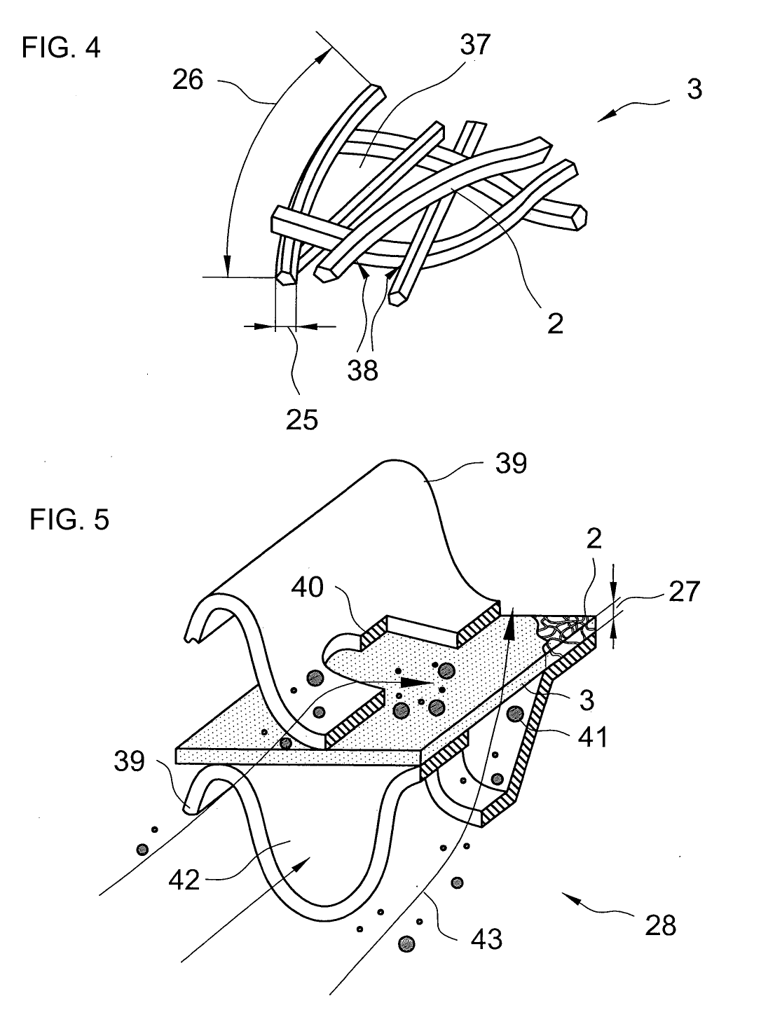

FIG. 4 illustrates a portion of the knitted fabric 3, in which in particular a fiber length 26 and a fiber diameter 25 are indicated. The fibers 2, which are pressed against one another during the welding method, form multiple welded connections 38 as a result of the resistance heating due to the welding current at the contact regions. Nonetheless, a plurality of passages or channels 37 are realized in the knitted fabric 3, in such a way that a knitted fabric 3 of this kind can be used in particular as cushioning or filter material.

FIG. 5 illustrates an exhaust-gas treatment component 28 for filtering exhaust gases. The exhaust gases are passed through the exhaust-gas treatment component 28 in a flow direction 43, in the course of which, for example, particles 41 contained therein are retained on the fibers 2 of the knitted fabric 3 having a predetermined height 27. To this end, the exhaust-gas treatment component 28 has a plurality of layers 39 which form channels 42 through which the exhaust gas can flow. Guide blades 40 may be additionally provided in order to generate a non-laminar flow. The guide blades 40 deflect the gas flow toward the knitted fabric 3. Such an exhaust-gas treatment component can preferably be used in exhaust systems of automobiles.

1. An apparatus for welding metallic fibers to form a knitted fabric having a predetermined width, the apparatus comprising:
a plurality of welding electrode pairs to be distributed over the predetermined width of the knitted fabric to be formed and through which the metallic fibers are to be passed;
at least one stroke configuration effecting a relative movement of at least one welding electrode of a welding electrode pair;
at least one welding control feeding a welding current as a function of a contact between a welding electrode pair and the metallic fibers; and
a feed control for moving the knitted fabric, said feed control feeding the knitted fabric as a function of a state of said at least one stroke configuration.

2. The apparatus according to claim 1, wherein said welding electrode pairs have an effective area of 2 to 10 cm².

3. The apparatus according to claim 1, wherein said stroke configuration moves all of said welding electrode pairs together.

4. The apparatus according to claim 1, wherein said stroke configuration is an eccentric drive.

5. The apparatus according to claim 1, wherein said welding control includes a transformer and a frequency-controlled converter to be matched to a movement of said stroke configuration.

6. The apparatus according to claim 1, wherein said welding electrode is configured to perform at least 300 strokes per minute.

7. The apparatus according to claim 1, wherein said welding electrode pair has a cooling system.

8. The apparatus according to claim 1, which further comprises a position-recognition unit disposed upstream of said welding electrode pairs for at least checking or setting a position of the metallic fibers.

9. The apparatus according to claim 1, which further comprises a seaming unit disposed downstream of said welding electrode pairs, said seaming unit at least compacting or welding an edge region of the knitted fabric.

10. A method for welding metallic fibers to form a knitted fabric having a predetermined width, the method comprising the following steps:
a) feeding a composite of metallic fibers to an apparatus for welding the fibers to form the knitted fabric; and
b) separately welding a plurality of sections of the composite in a time segment in which the composite is stationary.

11. The method according to claim 10, wherein step b) includes a welding operation lasting less than 4 milliseconds in an individual section.

12. The method according to claim 10, which further comprises carrying out step b) at a repeat rate of at least 300 welding operations per minute.

13. The method according to claim 10, which further comprises carrying out individual welding operations with at least one of the following parameters:
a welding electrode contact pressure within a range of 5,000 to 50,000 N/cm²;
a welding current within a range of 300 to 1,200 amps;
a welding power within a range of 500 to 20,000 watts.

14. The method according to claim 10, which further comprises carrying out step a) with an average feed of at least 3 meters per minute.

15. The method according to claim 10, which further comprises orienting the composite relative to the apparatus for welding, before step a).

16. The method according to claim 10, which further comprises feeding the knitted fabric to a seaming unit after step b) for setting the predetermined width of the knitted fabric.

17. The method according to claim 10, which further comprises producing the knitted fabric with at least one of the following properties:
fibers having a hydraulic fiber diameter of 10 to 100 μm;
fibers having a ratio of fiber length to hydraulic fiber diameter of 50 to 5,000;
fibers having a variance of the fiber diameter of at most 50%;
a width of the knitted fabric of 5 to 500 mm;
a height of the knitted fabric of 0.1 to 10 mm;
a weight per unit area of the knitted fabric of 100 to 5,000 g/m²;
an increase in strength from the composite to the knitted fabric of at least a factor of 3;
a porosity of the knitted fabric of 50 to 85%.

18. A method for filtering exhaust gases, comprising the following steps:
filtering the exhaust gases with a knitted fabric produced with the apparatus according to claim 1.

19. A method for filtering exhaust gases, comprising the following steps:
filtering the exhaust gases with a knitted fabric produced by the method according to claim 10.

20. An exhaust-gas treatment component for cleaning exhaust gases, the exhaust-gas treatment component comprising:
at least one knitted fabric produced with the apparatus according to claim 1.

21. An exhaust-gas treatment component for cleaning exhaust gases, the exhaust-gas treatment component comprising:
at least one knitted fabric produced by the method according to claim 10.
